(19) United States
(12) Patent Application Publication
(10) Pub. No.: US 2026/0355773 A1
(43) Pub. Date: Nov. 12, 2026

(54) Reversible spray nozzle, spray head and application device comprising such a nozzle and associated unclogging method

(71) Applicant: EXEL INDUSTRIES, EPERNAY (FR)

(72) Inventors: Pierre Shinji DEVINES, INGRE (FR); Paulo DOS SANTOS, Aulnay-sous-Bois (FR); Pascal Laurent BUATOIS, NOISY LE SEC (FR)

(21) Appl. No.: 19/668,809

(22) Filed: May 6, 2026

(30) Foreign Application Priority Data
May 6, 2025 (FR) 2504815

(51) Int. Cl. B05B 15/534; B05B 7/06; B05B 12/00

(52) U.S. Cl. CPC B05B 15/534; B05B 7/06; B05B 12/002

(57) ABSTRACT

A spray nozzle for spraying a product, the nozzle defining a passage for circulation of the product extending according to a spray direction between an inlet end and an outlet end and opening to the outside of the nozzle by a spray orifice at the outlet end. The nozzle is reversible and is able to pivot about a longitudinal axis of the nozzle, normal to the spray direction. The nozzle includes a nozzle body defining a through duct and a spray insert housed in the through duct and defining the spray orifice of the nozzle. The nozzle body includes a central part having a general spherical shape presenting at least one material recess on the outlet end side.

### CROSS-REFERENCE TO RELATED APPLICATION

This application is a U.S. non-provisional application claiming the benefit of French Application No. 25 04815, filed on May 6, 2025, which is incorporated herein by reference in its entirety.

### TECHNICAL FIELD OF THE INVENTION

The present invention relates to a spray nozzle for spraying a product, for example a coating product, the nozzle defining a passage for circulation of the product through the nozzle, the passage extending according to a spray direction between an inlet end and an outlet end and opening to the outside of the nozzle by a connection orifice at the inlet end and by a spray orifice, suitable for spraying the product, at the outlet end, the nozzle being able to pivot about a longitudinal axis of the nozzle, normal to the spray direction.

The present invention also relates to a spray head including such a nozzle, as well as an associated application device.

### BACKGROUND OF THE INVENTION

Product application devices, such as spray guns, are known. They are intended to ensure the breakup of a product into fine droplets in such a manner as to coat a large surface with a small quantity of product. To this end, the product is supplied under pressure by a source and conveyed to a spray nozzle.

In mixed spraying technology, the product is supplied by the source at high pressure, typically at a pressure between 20 and 300 bar. As in the case of airless spraying, the narrowness of the spray orifice causes breakup of the product. However, this spraying is not optimal, given the relatively low pressure at which the product is supplied by the source. To improve atomization of the product, compressed air is blown at the nozzle outlet. Compressed air is also blown onto the ends of the jet to fold back the sprayed product and avoid the formation of concentrated paint parts, called horns, at these product pressures. This solution allows to obtain a good finishing quality, comparable with airless spraying, but with a better transfer rate, being more economical since, for the same product, it is supplied at a lower pressure.

Given the small dimensions of the nozzle outlet orifices and the viscosity of the products used, there is a risk of the nozzles clogging during use, in particular at their spray orifice.

Unclogging and cleaning the nozzles then require their disassembly, which takes time.

Reversible nozzles are known, able to be turned over, in such a manner as to circulate a product in the reverse direction to the usual spray direction, the product thus entering the nozzle by the spray orifice. This turning over thus allows to unclog the spray orifice.

EP 0 912 255 B1 discloses such a reversible nozzle. The nozzle includes a body, of cylindrical shape, in which a spray insert is housed. The nozzle can be pivoted by turning the body by means of a key.

However, such a solution is not entirely satisfactory.

Indeed, such nozzles are not suitable for devices implementing mixed spraying. Notably, they do not allow to blow air correctly at the nozzle outlet, so that atomization of the ejected liquid film is not optimal.

### SUMMARY OF THE INVENTION

An objective of the invention is to propose a reversible nozzle that is able to be used in a device implementing mixed spraying, while retaining satisfactory transfer rates and finishing qualities.

To this end, the invention has as its object a nozzle of the aforementioned type, characterized in that the nozzle includes a nozzle body defining a through duct, and a spray insert housed in the through duct, the insert defining the spray orifice of the nozzle, the nozzle body including a central part in which the through duct is defined and having a general spherical shape presenting at least one material recess on the outlet-end side.

The nozzle according to the invention thus allows to obtain a finishing quality and a transfer rate similar to those usually encountered in mixed spraying, while benefiting from the advantages of a reversible nozzle.

Indeed, the nozzle may be turned over to facilitate cleaning, without requiring disassembly that would be time consuming, delicate, and messy.

The shape of the central part of the nozzle in turn allows optimal atomization of the ejected liquid film, by allowing gas projection as close as possible to the nozzle outlet, notably directly at the spray orifice.

According to other advantageous aspects of the invention, the nozzle includes one or more of the following features, taken alone or according to all technically possible combinations:
the central part presents a general truncated sphere shape on the outlet end side, in such a manner as to define an annular shoulder surrounding the insert, or the central part presents a general spherical shape presenting at least one groove on the outlet end side, the groove extending according to a direction substantially parallel to the longitudinal axis;
the nozzle body includes a central piece forming the central part and at least a first support piece of general cylindrical shape, the support piece being configured to be mounted, preferably removably, on the central piece while projecting from the central piece according to the longitudinal axis, the first support piece and the central piece being secured in rotational in the mounted position;
the nozzle body further includes a second support piece of general cylindrical shape, the second support piece being configured to be mounted, preferably removably, on the central piece of the nozzle, the first and second support pieces projecting on either side of the central piece according to the longitudinal axis, the support pieces and the central body being secured in rotation in the mounted configuration;
at least one, preferably each, support piece defines at least one blowing channel intended to blow a jet of gas, preferably air, in the direction of the spray orifice;
the or each support piece defines at least one first blowing channel intended for projecting a gas flow onto a jet of product exiting the spray orifice;
the or each support piece defines at least one second blowing channel, preferably two second channels, intended for projecting a gas flow onto the spray insert;
the central piece includes at least one tenon projecting from the central part according to the longitudinal axis, the at least one support piece defining a bore configured to receive the tenon;
the nozzle includes a handle able to be mounted on the or one of the support pieces, the handle being able to be turned by a user or an automated device, in such a manner as to rotate the nozzle body;
the annular shoulder presents a frustoconical annular rim delimiting an opening, the spray insert being flush with said annular rim;
the insert presents an oblong shape;
the nozzle further includes a sleeve housed in the through duct in such a manner as to hold the insert in position.

The invention also relates to a spray head for a product application device, for example a coating product, such as a spray gun, the head including an annular ring presenting a central orifice, and a spray nozzle of the aforementioned type, the nozzle being removably housed in the central orifice, the nozzle being movable by rotation about the longitudinal axis between a spraying configuration, in which the connection orifice opens into the central orifice, and a cleaning configuration, in which the spray orifice opens into the central orifice.

According to a particular embodiment, the ring presents an upstream face for connection to a body of the application device and a downstream face oriented opposite said upstream face, the ring defining at least one blowing channel intended to receive a compressed gas and opening into the downstream face at a projection orifice, the channel being configured to project the gas through the projection orifice in the direction of a jet of product sprayed by the spray orifice.

The invention also relates to a product application device, for example a coating product, such as a spray gun, including a spray head of the aforementioned type.

The invention also relates to a method for unclogging a spray nozzle of an application device of the aforementioned type, the method including the following operations:
providing an application device of the aforementioned type;
switching the spray nozzle to its cleaning configuration;
supplying the nozzle, by the spray orifice, with an unclogging product, the unclogging product being at a pressure between 20 and 300 bar.

### BRIEF DESCRIPTION OF THE DRAWINGS

The invention will appear more clearly upon reading the following description, given solely by way of a non-limiting example, and made with reference to the drawings in which:

FIG. 1 is a partial perspective view, three-quarters front, of an application device according to the invention, the application device including a spray head according to a first embodiment of the invention;

FIG. 2 is a longitudinal sectional view of the spray head of FIG. 1, the spray head including a spray nozzle according to the invention, the nozzle being in spraying configuration;

FIG. 3 is a perspective view, three-quarters front (left) and one-quarter rear (right), of the spray nozzle of FIG. 2;

FIG. 4 is a longitudinal sectional view of a part of the spray nozzle of FIG. 3; the section plane being indicated by plane IV-IV in FIG. 3;

FIG. 5 is a longitudinal sectional view of a part of the spray nozzle of FIG. 3; the section plane being indicated by plane V-V in FIG. 3;

FIG. 6 is a perspective view of a central piece of the nozzle of FIG. 3;

FIG. 7 is a longitudinal sectional view of the spray head of FIG. 2, the nozzle being in cleaning configuration;

FIG. 8 is a perspective view of an alternative of the central piece of FIG. 6; and

FIG. 9 is a longitudinal sectional view of a spray head according to a second embodiment of the invention.

### DETAILED DESCRIPTION

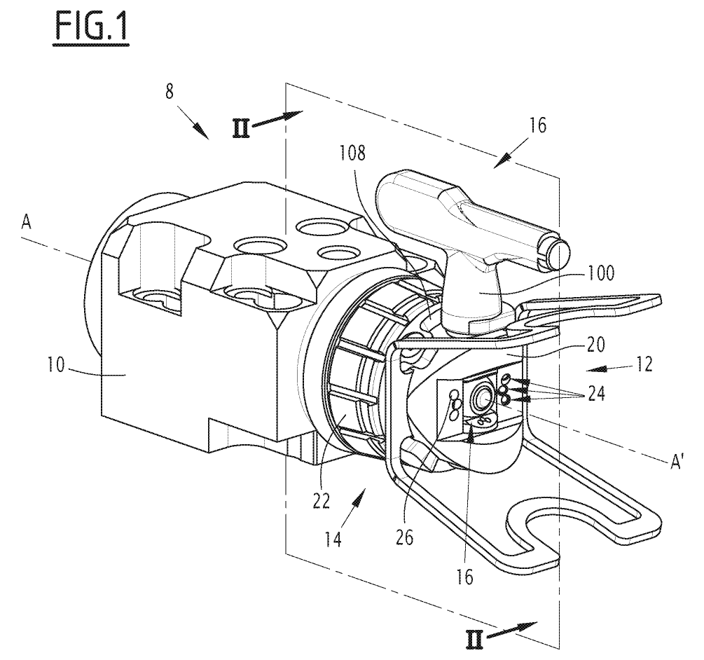

FIG. 1, partly represents an application device 8 for a product according to a first embodiment.

Application device 8 is intended to apply the product to a surface. The product is preferably a fluid, for example a liquid including one or more components or a powdery material. It may be a coating product, such as a paint, a primer, a varnish, etc. Alternatively, the product is a fire-retardant product or a protective product.

In the following, the orientation terms “upstream” and “downstream” are understood with reference to the direction of circulation of the coating product in device 8 under normal product spraying conditions, the product flowing from upstream to downstream.

In the example of FIG. 1, application device 8 is a spray gun, in particular a manual spray gun. Alternatively, the spray gun is an automatic spray gun.

Application device 8 is configured to be supplied with the product to be applied and with compressed gas, respectively by a product source and by a compressed gas supply (not represented).

The product source is able to supply the product at an outlet pressure between 20 and 300 bar.

The compressed gas supply is able to supply a gas, typically air, compressed, preferably at a pressure between 0.2 and 6 bar.

Device 8 includes a body 10 (only part of which is visible in FIG. 1). Device 8 further includes a positioning base and a piloted piston (in the case of an automatic device), or a grip stock and an actuating trigger (in the case of a manual device).

Device 8 also includes a spray head 12 mounted on body 10.

Spray head 12 is centered on a spray direction A-A’ of device 8.

Spray head 12 includes an annular ring 14 presenting a central orifice 16, and a spray nozzle 18 housed at least partially in central orifice 16.

Central orifice 16 opens on the one hand at a downstream face 14A of ring 14 and on the other hand at an upstream face 14B of ring 14, opposite downstream face 14A.

Annular ring 14 is centered on spray direction A-A’. Ring 14 is able to be connected to body 10 of device 8 at its upstream face 14B.

Ring 14 includes a body 20 defining central orifice 16, and a skirt 22 mounted so as to rotate about spray direction A-A’ relative to body 20.

Preferably, as visible in FIG. 1, ring 14 defines blowing channels 24 intended to pass a compressed gas and opening into downstream face 14A of annular ring 14 at projection orifices 26. Orifices 26 are arranged on either side of central orifice 16. Channels 24 are configured to project a compressed gas, typically air, in the direction of a jet of product sprayed by spray nozzle 18. This allows to control the width of the product jet and to avoid the formation of horns.

Each channel 24 is fluidly connected to the compressed gas supply.

For example, in the embodiment of FIG. 1, ring 14 includes two groups of three orifices 26 arranged on either side of central orifice 16, diametrically opposite.

Orifices 26 are shaped to guide air jets toward spray direction A-A’. Thus, the air jets coming from orifices 26 have a centripetal direction relative to spray direction A-A’ of the gun. For example, the air jets form an angle between 25° and 50° with spray direction A-A’. For example, in the embodiment of FIG. 1, the air jets exiting the central orifices form an angle of 35° with spray direction A-A’, while the air jets exiting the peripheral orifices form an angle of 30° with spray direction A-A’.

Advantageously, to act on the shape of the product jet, the air jets meet at a distance between 5 mm and 15 mm from a spray orifice 35 (which will be described later). For example, in the embodiment of FIG. 1, the air jets meet respectively at a distance of 7 mm for the jets exiting the central orifices and 11 mm for the jets exiting the peripheral orifices.

Body 20 of ring 14 defines a bore 28 in which nozzle 18 is received at least in part. Bore 28 extends according to a longitudinal axis X-X’ of nozzle 18, normal to spray direction A-A’.

Spray nozzle 18 is housed in ring 14 in a removable manner.

Nozzle 18 is, for example, able to be mounted in bore 28 by sliding and rotation in bore 28.

Nozzle 18 is movable in rotation in bore 28 according to longitudinal axis X-X’. Thus, nozzle 18 is able to turn about longitudinal axis X-X’.

Nozzle 18 defines a passage 30 for circulation of the product through nozzle 18.

Passage 30 extends according to a transverse axis Y-Y’ of nozzle 18, normal to longitudinal axis X-X’. Transverse axis Y-Y’ is coincident with spray direction A-A’ during product spraying.

Passage 30 extends according to transverse axis Y-Y’ between an inlet end 32 and an outlet end 34. Passage 30 opens to the outside of nozzle 18 by a connection orifice 33 at inlet end 32 and through a spray orifice 35, able to spray the product, at outlet end 34.

Connection orifice 33 is fluidly connected to the product source.

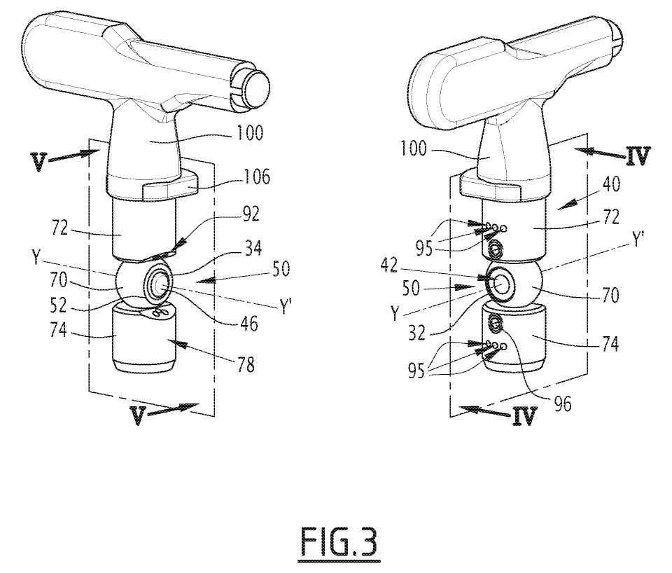

With reference to FIGS. 3 - 5, nozzle 18 includes a nozzle body 40 defining a through duct 42 extending according to transverse axis Y-Y’ between an upstream end 43 and a downstream end 44.

Nozzle 18 further includes a spray insert 46 housed in through duct 42, insert 46 defining spray orifice 35 of nozzle 18.

As visible in FIG. 3, nozzle body 40 includes a central part 50 defining through duct 42.

Central part 50 has a general spherical shape presenting at least one material recess on outlet end 34 side.

The one or more material recesses on the sphere are intended to allow passage of the gas from channels 90A and 90B described further below.

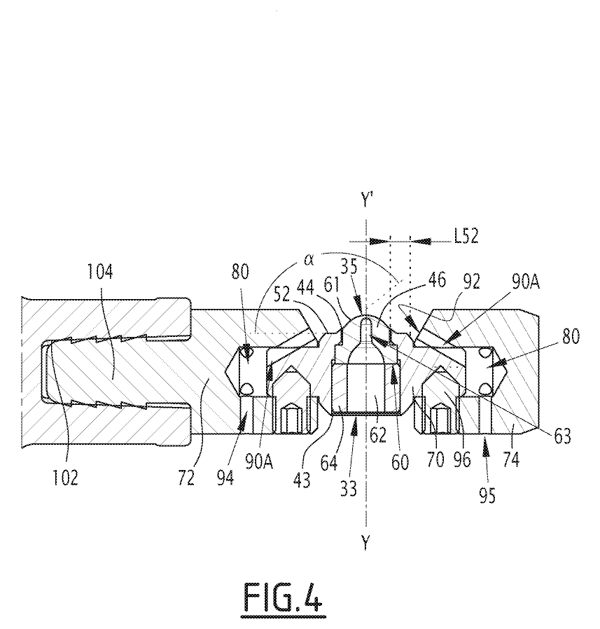

For example, as represented in FIG. 4, central part 50 has a general truncated sphere shape on outlet end 34 side. Central part 50 here presents an annular shoulder 52 at downstream end 44 of through duct 42.

As visible in FIG. 4, central part 50 thus presents a sphere shape cut in such a manner as to remove a cap of material on outlet end 34 side.

Annular shoulder 52 presents a crown shape.

The crown preferably presents a width L52 large enough to allow passage of the gas, but small enough to maintain a continuous spherical surface intended to ensure sealing in the cleaning configuration.

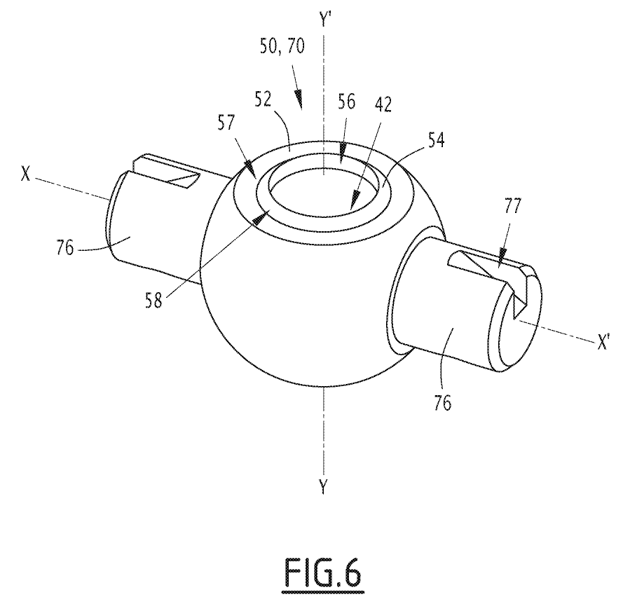

Advantageously, as visible in more detail in FIG. 6, annular shoulder 52 further includes a frustoconical annular rim 54 delimiting an opening 56 at downstream end 44.

Annular shoulder 52 here incudes, according to a radial direction toward axis Y-Y’, a peripheral face 57 normal to axis Y-Y’, and a central face 58 that is beveled, central face 58 forming an angle α with peripheral face 57, so that central face 58 is advantageously tangential to insert 46.

Spray insert 46 is inserted at least in part into through duct 42.

Insert 46 presents an upstream face 60, housed in duct 42, and a downstream face 61 opposite upstream face 60 and arranged outside duct 42.

Upstream face 60 is substantially planar and is arranged substantially transverse to axis Y-Y’.

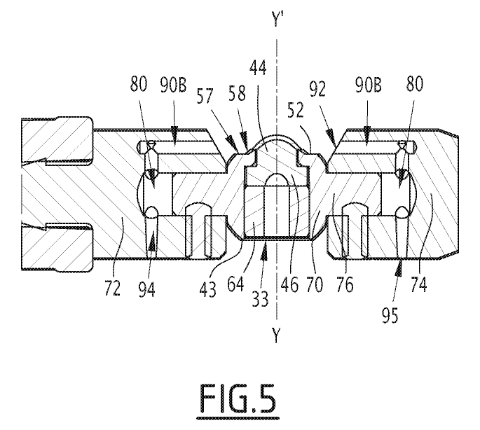

Downstream face 61 of insert 46 is typically dome-shaped, centered on axis Y-Y’. Advantageously, as visible in FIGS. 4 and 5, downstream face 61 of insert 46 is advantageously flush at its periphery with rim 54.

Insert 46 defines spray orifice 35 at its downstream face 61.

Furthermore, insert 46 includes, from upstream to downstream, a cavity 62 of transverse cross section decreasing toward the downstream, followed by a channel 63 of substantially constant transverse cross section fluidly connecting cavity 62 to spray orifice 35.

In the example of FIG. 4, cavity 62 presents substantially a bell shape.

Channel 63 presents a diameter smaller than that of the cavity 62, leading to spray orifice 35 that is even smaller and may become obstructed.

Advantageously, insert 46 presents, at its upstream face 60, an oblong shape. Such a shape facilitates positioning of insert 46 in through duct 42, and in particular its angular orientation, relative to nozzle body 40, and in particular central part 50.

Insert 46 presents a slit configured to generate and orient the sprayed jet of product. The oblong shape of insert 46 allows to easily position the insert and thus to easily orient the jet sprayed relative to the compressed gas flows, the flows coming from channels 24 of the ring and channels 90A and 90B, defined later.

The oblong shape of insert 46 also facilitates assembly of insert 46 in nozzle body 40, without an additional grinding rework operation on the slit after assembly or an operation for adjusting the orientation of the insert in nozzle body 40.

Insert 46 is for example a carbide insert.

Insert 46 is preferably held in place in through duct 42 by bonding to an internal wall of through duct 42. This contributes to the sealing of its mounting.

Preferably, as visible in FIGS. 4 and 5, a sleeve 64 is housed in duct 42 in such a manner as to hold spray insert 46 in place. Sleeve 64 is for example press fitted into duct 42.

Advantageously, passage 30 presents a flow restriction (not represented), for example at sleeve 64. The restriction allows to limit the volume of product contained and have a retaining effect.

According to one advantageous embodiment (not represented), sleeve 64 presents a domed downstream face, dome-shaped. Such a shape allows to reduce volumes likely to contain product.

According to the embodiment of FIG. 3, nozzle body 40 includes a central piece 70, a first support piece 72 and a second support piece 74. First and second support pieces 72, 74 project on either side of central piece 70 according to longitudinal axis X-X’.

Advantageously, at least one of support pieces 72, 74 is mounted removably on central piece 70. Preferably, both support pieces 72, 74 are mounted removably on central piece 70.

FIG. 6 represents central piece 70 alone.

As visible in FIG. 6, central piece 70 forms central part 50 of nozzle body 40.

Central piece 70 thus defines through duct 42, as well as annular shoulder 52. Central piece 70 thus forms an insert holder for insert 46.

Preferably, central piece 70 further includes assembly means for support pieces 72, 74.

For example, as visible in FIG. 6, central piece 70 includes at least one tenon 76 projecting from spherical central part 50 according to longitudinal axis X-X’, tenon 76 being intended to be received in a cavity provided in one of support parts 72, 74. Preferably, central piece 70 includes two tenons 76 projecting on either side of spherical central part 50, according to diametrically opposite directions.

For example, the or each tenon 76 presents a substantially cylindrical shape.

Advantageously, as will be described later, the or each tenon 76 presents a groove 77 intended for air passage.

Preferably, central piece 70 is substantially symmetrical relative to a plane normal to axis X-X’ and passing through axis Y-Y’.

Preferably, first support piece 72 and second support piece 74 each present a substantially general cylindrical shape extending according to longitudinal axis X-X’. Each support piece 72, 74 is radially delimited by a cylindrical face 78.

First support piece 72 and second support piece 74 include means complementary to the assembly means of central piece 70, allowing assembly of nozzle body 40.

For example, as represented in FIGS. 4 and 5, first support piece 72 and second support piece 74 each include a bore 80 configured to receive a respective tenon 76 of central piece 70.

Advantageously, at least one of support pieces 72, 74 presents at least one blowing channel 90A, 90B intended to blow a jet of gas, preferably air, in the direction of the spray orifice.

Advantageously, each air channel 90A, 90B is fluidly connected to the compressed gas supply.

Preferably, as visible in FIGS. 3-5, first support piece 72 and second support piece 74 each define at least one central channel 90A and two peripheral channels 90B, notably three blowing channels 90A, 90B.

Each channel 90A, 90B is intended to receive a compressed gas, preferably compressed air. Each channel 90A, 90B opens on downstream face 14A side of spray head 12 at a gas projection orifice 92 and is configured to project the gas in the direction of a jet of product sprayed by spray orifice 35.

Advantageously, as visible in FIGS. 4 and 5, the or each support piece 72, 74 includes channels 90A, 90B opening at their respective projection orifice 92 according to different directions.

For example, as visible in FIGS. 3 - 5, each support piece 72, 74 includes a central channel 90A (visible in FIG. 4) opening obliquely and two peripheral channels 90B (visible in FIG. 5), arranged on either side of central channel 90A, opening radially to spray direction A-A’.

Advantageously, each channel 90A is configured to project the gas toward spray direction A-A’ at a downstream distance from spray orifice 35 that is less than 2 mm, preferably less than 0.7 mm.

The shape of central portion 50 and the positioning of channels 90A, at support pieces 72, 74, thus allow gas to blow as close as possible to spray orifice 35.

Advantageously, each channel 90B is configured to project gas on either side of the dome of insert 46, formed by downstream face 61, at an upstream distance from spray orifice 35 that is greater than 0.5 mm, preferably greater than 1.6 mm.

The shape of central part 50 and the positioning of channels 90B, at support pieces 72, 74, thus allow gas to blow as close as possible to the base of the dome of insert 46.

FIGS. 4 and 5 correspond to sectional views of nozzle 18 according to planes IV-IV and V-V represented in FIG. 3, plane IV-IV passing by central channels 90A and plane V-V passing by two of peripheral channels 90B.

Projection orifices 92 are able to guide gas jets in direction of spray direction A-A’. Thus, the jets coming from orifices 92 advantageously have a substantially radial and centripetal direction relative to spray direction A-A’ of the gun. Here, the adjective “substantially” means that there is a deviation of at most a few degrees between a direction strictly radial to spray direction A-A’ and the direction of the gas jets.

For example, central channel 90A forms an angle between 15° and 40°, preferably 30° with a direction strictly normal to spray direction A-A’.

Advantageously, channel 90A is preceded in part in its extension by groove 77 provided in tenon 76 of central piece 70.

Gas thus reaches, via channels 90A, the product jet as close as possible to spray orifice 35, promoting breakup of the product into fine droplets.

channels 90B are themselves configured to project gaseous flows flush with or arriving at annular shoulder 52 and at the dome of insert 46, and more particularly, advantageously tangential to peripheral face 57.

Via channels 90B, gas reaches insert 46, to remove any deposits of product that may be present there and to prevent deposits, including as mist, during spraying.

According to the embodiment of FIGS. 4 and 5, channels 90A, 90B open into bore 80 of respective support piece 72, 74, supply channels 94 opening on the one hand into bore 80 and on the other hand at orifices 95 provided on cylindrical face 78 of support piece 72, 74.

Other arrangements of blowing channels in support pieces 72, 74 are possible.

For example, according to one alternative, channels 90B do not open into bore 80, but into an annular groove provided on cylindrical face 78 of support piece 72, 74.

In the mounted configuration, support pieces 72, 74 and central piece 70 are secured in rotation. For example, nozzle body 40 includes fastening means, such as pins 96 or screw elements, allowing to fasten central piece 70 to support pieces 72, 74.

Advantageously, the fastening means are reversible. This means that the means may be undone in such a manner as to separate support pieces 72, 74 from central piece 70.

As previously described, nozzle 18 is able to pivot about longitudinal axis X-X’ of the nozzle when it is mounted on annular ring 14.

Thus, nozzle 18 is movable by rotation about longitudinal axis X-X’ between a spraying configuration and a cleaning configuration.

The changeover between the spraying configuration and a cleaning configuration is carried out by rotating nozzle 18 through an angle of 180° about longitudinal axis X-X’.

In the spray configuration, as represented, in FIGS. 1 - 5, connection orifice 33 opens into central orifice 16 and spray orifice 35 opens to outside of body 20 of ring 14.

In the cleaning configuration, spray orifice 35 opens into central orifice 16 and connection orifice 33 opens to outside of body 20 of ring 14.

The direction of circulation of the product in spray insert 46 therefore changes depending on the chosen configuration.

Preferably, nozzle 18 includes a handle 100 able to be mounted on the or one of support pieces 72, 74, in such a manner as to be secured in rotation. In the example of FIG. 1, handle 100 is mounted on first support piece 72. Handle 100 is able to be turned by a user to switch nozzle 18 from its spraying configuration to its cleaning configuration, and vice versa.

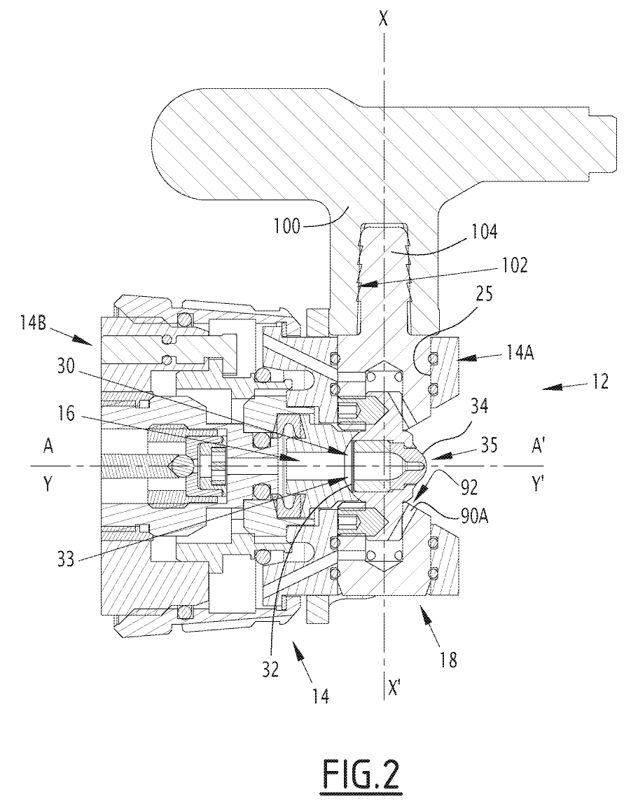

For example, as visible in FIG. 2, handle 100 includes a bore 102, configured to receive a rod 104 projecting from first support piece 72, for example by force snap-fitting or by over-molding.

Preferably, as visible in FIG. 1, device 8 includes a nozzle 18 locking system intended to interrupt rotation of nozzle 18. The locking system allows positioning of nozzle 18 in its spraying and cleaning configurations.

For example, handle 100 includes a stop means 106 (visible in FIG. 3), formed for example by a base of handle 100, intended to come into contact with a counter stop 108 (visible in FIG. 1) mounted on ring 14 when nozzle 18 is in spraying configuration and when nozzle 18 is in cleaning configuration, in such a manner as to interrupt rotation of nozzle 18.

The operation of application device 8 according to the first embodiment will now be described.

For example, device 8 is here a manual device.

First, the product source and the compressed gas supply are activated. Application device 8 is then supplied with product and gas under pressure.

Nozzle 18 is in spraying configuration.

A user presses the trigger in such a manner as to supply spray head 12 with product.

Spray nozzle 18 is then supplied, by its connection orifice 33, with product, the product being at a pressure between 20 and 300 bar.

The product, arriving under pressure, thus passes through spray insert 46, first passing through cavity 62 then through channel 63. Product is then sprayed out of spray insert 46 through spray orifice 35 and disperses out of nozzle 18 as droplets.

At least simultaneously, and preferably prior to product spraying, blowing channels 90A, 90B of nozzle 18 are supplied with gas under pressure and project compressed gas in the direction of spray orifice 35 and the dome of insert 46.

The gas projected through projection orifices 92 then come to strike the location and then the product flow and breaks up the droplets. Gas blown by channels 90 arrives as close as possible to spray orifice 35, so that the product flow is atomized by the air flow as soon as it exits spray insert 46.

Advantageously, blowing channels 24 of ring 14 are also supplied with gas under pressure and project compressed gas in the direction of the product jet, in such a manner as to control the jet width.

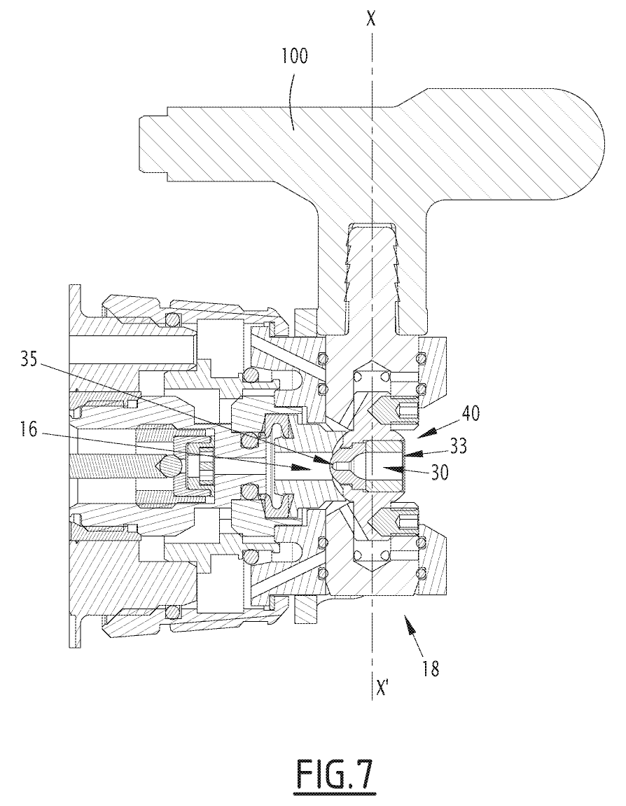

When the user wishes to unclog spray nozzle 18, the user stops pressing the trigger and switches spray nozzle 18 to its cleaning configuration, such as represented in FIG. 7.

To do this, the user grasps handle 100 and turns it by 180°C. Rotation of handle 100 causes rotation of the rest of nozzle body 40.

Following turning of nozzle 18, spray orifice 35 opens into central orifice 16 and the connection orifice opens outside body 20.

The user may then press the trigger and pass pressurized product through nozzle 18. Nozzle 18 is thus supplied by spray orifice 35 with an unclogging product, preferably with the product. The product first passes through channel 63, then through cavity 62 of insert 46. The unclogging product is preferably at a pressure between 20 and 300 bar. Advantageously, the user does not change the pressure setting.

Then, the user my return nozzle 18 to its spraying configuration, by turning handle 100 in the opposite direction.

Advantageously, compressed gas is then projected onto insert 46 by means of channels 90B, by pressing the trigger, in order to clean insert 46 and its periphery of any remaining product. Projection of gas alone without product spraying is for example carried out by pressing the trigger for a given time, for example, between a few tenths of a second and 3 seconds, and/or by partially depressing the trigger.

By means of the invention described above, a finishing quality and a transfer rate similar to those usually encountered in mixed spraying are thus obtained, while benefiting from the advantages of a reversible nozzle.

Indeed, nozzle 18 may be used as a conventional reversible nozzle for example in mixed spraying, and thus may be turned over to facilitate cleaning, without requiring disassembly of nozzle 18 that would be time-consuming, delicate, and messy.

The shape of central part 50 of nozzle 18 in turn allows optimal atomization of the ejected liquid film, by allowing air projection as close as possible to the nozzle outlet, in particular directly at spray orifice 35.

The air flows are thus not deflected by the shape of nozzle 18, but may, thanks to the absence of a cap of material at central piece 50, or to the presence of grooves, reach spray orifice 35 as well as the dome of insert 46 and thus allow breakup into fine droplets of the sprayed product.

The arrangement of air channels 90A, 90B directly in the nozzle body, at support pieces 72, 74, contributes to this by allowing air blowing flush with and onto insert 46.

Nozzle 18 according to the invention is therefore a reversible nozzle adapted for devices implementing mixed spraying.

The removable nature of the parts of the nozzle body further allows replacement of the various pieces 70, 72, 74 if needed. Central piece 70 may thus easily be replaced, while keeping support pieces 72, 74.

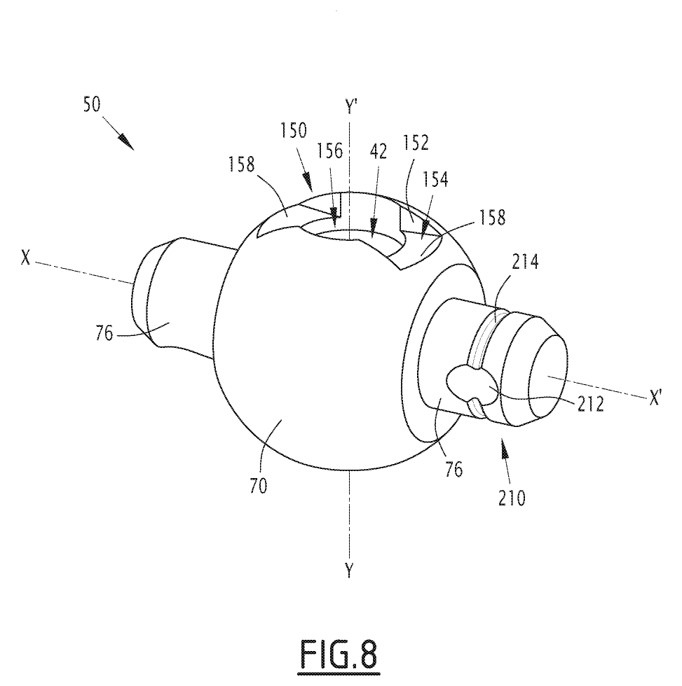

FIG. 8 represents an alternative of central part 50, and more particularly of central piece 70 of FIG. 6. According to this alternative, central part 50 has a general spherical shape presenting a groove 150 provided on outlet end 34 side, groove 150 extending according to a direction substantially parallel to longitudinal axis X-X’.

Groove 150 thus forms a passage for the gas coming from channels 90A, 90B.

Groove 150 is laterally delimited by two lateral rims 152 and presents a bottom 154, through duct 42 opening at bottom 154 by an opening 156.

Groove 150 here defines two shoulders 158 on either side of opening 156.

In the example of FIG. 8, bottom 154 is planar and extends normally to axis Y-Y’.

Alternatively, bottom 154 is not planar. Bottom 154 presents, for example, a rounded shape and/or each shoulder 158 is beveled and forms a non-zero angle with axis X-X’.

In the example of FIG. 8, lateral rims 152 extend according to transverse axis Y-Y’, perpendicular to bottom 154.

Alternatively, lateral rims 152 are inclined relative to axis Y-Y’, and form with bottom 154 an angle greater than 90°.

Other shapes of grooves 150 are possible.

Central part 50 according to this alternative allows to minimize the volume of sphere removed, while ensuring passage of gas flows from channels 90A, 90B. This also allows to reduce volumes likely to contain product.

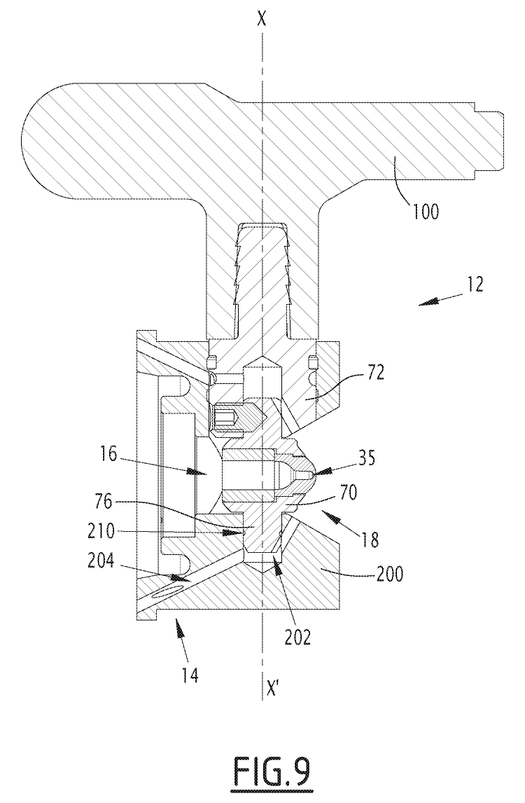

FIG. 9 represents a spray head 12 according to a second embodiment. In the following, only differences relative to the first embodiment are mentioned for concision. In addition, similar or identical elements to those of the first embodiment retain their numerical references, while other elements bear other references.

Spray head 12 includes an annular ring 14 presenting a central orifice 16, and a spray nozzle 18 housed in central orifice 16.

In this second embodiment, body 40 of nozzle 18 incudes a central piece 70 and only one support piece 72 such as defined above.

Central piece 70 may present a truncated spherical shape, as in the alternative of FIG. 6, or a spherical shape presenting a groove, as in the alternative of FIG. 8.

Ring 14 directly integrates functions of the second support piece of the first embodiment.

Thus, ring 14 includes a support part forming a base 200 for the nozzle body.

For example, as represented in FIG. 9, base 200 defines a bore 202 intended to receive a tenon 76 of central piece 70 of the nozzle body.

Base 200 further defines at least one blowing channel 204, preferably a plurality of channels 204, configured to blow a compressed gas in the direction of spray orifice 35. For example, base 200 presents a channel arrangement 204 similar to the arrangement of first support piece 72. Base 200 includes, for example, a central channel and two peripheral channels arranged on either side of the central channel, similar to channels 90A, 90B of second support piece 74 of the first embodiment.

Channels 204 may or may not open into bore 80.

Channels 204 of base 200 are able to blow away any drops of product likely to flow from passage 30, for example, in the case of a product presenting high fluidity.

Nozzle 18 according to the second embodiment thus presents a smaller number of pieces, and therefore a reduced cost. In addition, its assembly and disassembly are facilitated.

Advantageously, according to this second embodiment, the locking system of nozzle 18 locking system intended to interrupt rotation of nozzle 18 is formed by an indexing system 210, instead of a stop/counter-stop system.

Indexing system 210 includes, for example, at least one spring plunger (not represented) installed in base 200 and including a movable element, preferably a ball, intended to fit in a reversible manner into a housing 212 provided in a tenon 76 of central piece 70.

“Reversible” means being able to retract the movable element of the plunger by manually turning handle 100.

Such a housing 212 is visible notably on the piece of FIG. 8.

Thus, a tenon 76 of central piece 70 defines at least one housing 212 intended to receive the ball of a spring plunger. Preferably, tenon 76 includes two housings 212 diametrically opposite, allowing indexing of the nozzle in the spraying configuration and in the cleaning configuration.

Preferably, as visible in FIG. 8, tenon 76 presenting housing(s) 212 presents an annular groove 214 presenting a depth less than housing 212. Annular groove 214 thus allows to indicate the correct insertion height of nozzle 18 along axis X-X’, the ball of the indexing system 210 then being received in annular groove 214.

According to another embodiment (not represented), central piece 70 and support pieces 72, 74 are not removable from one another. For example, nozzle body 40 is formed as a single part.

1. A spray nozzle for spraying a product, the nozzle defining a passage for circulation of the product through the nozzle, the passage extending according to a spray direction between an inlet end and an outlet end and opening to the outside of the nozzle by a connection orifice at the inlet end and by a spray orifice, able to spray the product, at the outlet end, the nozzle being able to pivot about a longitudinal axis of the nozzle, normal to the spray direction, the nozzle comprising:
a nozzle body defining a through duct, the nozzle body comprising a central part wherein the through duct is defined and having a general spherical shape presenting at least one material recess on the outlet end side; and
a spray insert housed in the through duct, the insert defining the spray orifice of the nozzle.

2. The nozzle according to claim 1, wherein the product is a coating product.

3. The nozzle according to claim 1, wherein said spray insert presents an oblong shape.

4. The nozzle according to claim 1, wherein said central part presents a general truncated spherical shape on the outlet end side, in such a manner as to define an annular shoulder surrounding the insert, or said central part presents a general spherical shape presenting at least one groove on the outlet end side, the groove extending according to a direction substantially parallel to the longitudinal axis.

5. The nozzle according to claim 4, wherein the annular shoulder presents a frustoconical annular rim delimiting an opening, said spray insert being flush with said frustoconical annular rim .

6. The nozzle according to claim 1, wherein said nozzle body comprises:
a central piece forming said central part; and
a first support piece of a general cylindrical shape, the support piece being mounted on said central piece while projecting from said central piece according to the longitudinal axis, the first support piece and said central piece being secured in rotation in the mounted position.

7. The nozzle according to claim 6, wherein said first support piece is mounted in a removable manner on said central piece.

8. The nozzle according to claim 6, further comprising a second support piece of a general cylindrical shape, the second support piece being mounted on said central piece, said first and second support pieces projecting on either side of said central piece according to the longitudinal axis, said first and second support pieces and said central body being secured in rotation.

9. The nozzle according to claim 8, wherein said second support piece is mounted removably on said central piece.

10. The nozzle according to claim 6, wherein said first support piece defines at least one blowing channel blowing a jet of gas in the direction of the spray orifice.

11. The nozzle according to claim 10, wherein the gas is air.

12. The nozzle according to claim 10, wherein said first support piece defines at least one first blowing channel projecting a gas flow onto a jet of product exiting the spray orifice.

13. The nozzle according to claim 10, wherein said first support piece defines at least one second blowing channel projecting a gas flow onto said spray insert.

14. The nozzle according to claim 10, wherein said first support piece defines two second blowing channels projecting a gas flow onto said spray insert.

15. The nozzle according to claim 6, wherein said central piece comprises at least one tenon projecting from said central part according to the longitudinal axis, said first support piece defining a bore configured to receive said tenon.

16. The nozzle according to claim 6, comprising a handle mounted on said first support piece, the handle being turned by a user or an automated device, in such a manner as to rotate said nozzle body.

17. A spray head for a product application device, comprising:
an annular ring presenting a central orifice; and
a spray nozzle according to claim 1, the nozzle being housed in a removable manner in the central orifice, the nozzle being movable by rotation about the longitudinal axis between a spraying configuration, wherein the connection orifice of the nozzle opens into the central orifice, and a cleaning configuration, wherein the spray orifice of the nozzle opens into the central orifice.

18. The spray head according to claim 17, wherein said annular ring presents an upstream face for connection to a body of the application device and a downstream face oriented opposite the upstream face, said ring defining at least one blowing channel receiving a compressed gas and opening into the downstream face at a projection orifice, the channel projecting the gas by the projection orifice in the direction of a jet of product sprayed by the spray orifice of said nozzle.

19. A product application device, comprising a spray head according to claim 17.

20. A method for unclogging a spray nozzle of a product application device, the method comprising:
providing a product application device according to claim 19;
switching the spray nozzle of the application device to its cleaning configuration; and
supplying the nozzle, by the spray orifice of the nozzle, with an unclogging product, the unclogging product being at a pressure between 20 and 300 bar.
